(19) United States
(12) Patent Application Publication
(10) Pub. No.: US 2003/0005389 A1
(43) Pub. Date: Jan. 2, 2003

(54) Test circuit for testing a synchronous circuit

(76) Inventors: Wolfgang Ernst, Munchen (DE); Gunnar Krause, Marht Schwaben (DE); Justus Kuhn, Munchen (DE); Jens Luepke, Munchen (DE); Jochen Mueller, Munchen (DE); Peter Poechmueller, Colchester, VT (US); Michael Schittenhelm, Poing (DE)

Correspondence Address: JENKINS & WILSON, PA, 3100 TOWER BLVD, SUITE 1400, DURHAM, NC, 27707, US

(21) Appl. No.: 10/140,223

(22) Filed: May 7, 2002

(30) Foreign Application Priority Data
May 10, 2001 (DE) 10122619.5

(51) Int. Cl. G06F 11/00

(52) U.S. Cl. 714/798

(57) ABSTRACT

Test circuit for testing a synchronous circuit (3) which is clocked with an operating clock signal with a high operating clock frequency, having:

(a) a frequency multiplication circuit (8), which receives a clock signal from an external test unit (2) and multiplies the low clock frequency of said clock signal by a specific factor for the purpose of generating the operating clock signal;

(b) a data comparison circuit (49), which is clocked with the operating clock signal, receives a data block read from the synchronous circuit (3) to be tested, which data block has a specific number (n) of data words n each comprising m data bits, and compares it with associated desired data words, each comprising m desired data, for the purpose of generating a corresponding number (n) of error data words each comprising m error data;

(c) a data register array (56), which has a plurality of data registers for buffer-storing the error data words generated;

(d) a first error compression circuit (58), which logically ORs the error data words buffer-stored in the data register array (56) to form a compressed error data word comprising m error bit [sic], which is buffer-stored in an error register;

(e) and having a second error compression circuit (60), which logically ORs the m error data contained in the compressed error data word to form an indication datum, the indication datum being output to the external test unit (2) with the low clock frequency, and indicating whether at least one data error has occurred in the data block read from the synchronous circuit (3) to be tested.

The invention relates to a test circuit for testing a synchronous circuit which is clocked with an operating clock signal with a high operating clock frequency, and in particular to a test circuit for testing a synchronous memory.

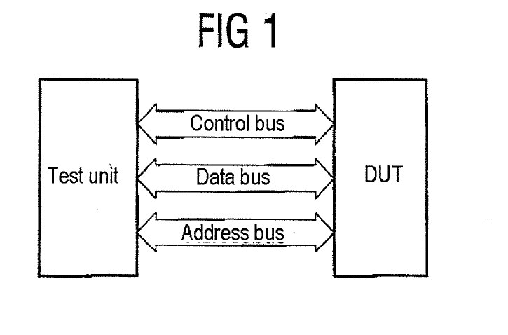

FIG. 1 shows a test arrangement according to the prior art.

A DUT (Device Under Test) to be tested is tested in respect of its functionality by an external test unit after the production process. For this purpose, the test unit applies control signals via a control bus, addresses memory cells of the circuit to be tested and, via a data bus, exchanges data with the memory module to be tested. The test unit generates test data patterns which are applied to addressed memory cells via the data bus. Afterward, the memory cells from the circuit to be tested are read and output via the data bus to the test unit. The test unit internally compares the applied test data patterns with the test data read from the memory module and checks whether or not the read-out test data corresponds to the expected test data. If the data do not correspond, non-functional memory cells are identified and, if appropriate, replaced by built-in, redundant memory cells in the memory module to be tested. If the number of discrepancies that occur is large, the memory module to be tested is identified as non-functional and is not supplied.

The synchronous memory module DUT to be tested is clocked with an operating clock signal which has a specific operating clock frequency. The operating clock frequencies at which dynamic memory modules operate are always increasing and are a few hundred megahertz. Conventional test units are unable to reliably test memory modules operated at such a high frequency.

Therefore, the object of the present invention is to provide a test circuit for a synchronous circuit operated with a high operating clock frequency by means of which the synchronous circuit can be tested reliably and with little additional outlay on circuitry by a conventional test unit.

This object is achieved according to the invention by means of a test circuit having the features specified in patent claim 1.

The invention provides a test circuit for testing a synchronous circuit which is clocked with an operating clock signal with a high operating clock frequency, having:

a frequency multiplication circuit, which receives a clock signal from an external test unit and multiplies the low clock frequency of said clock signal by a specific factor for the purpose of generating the operating clock signal,

a data comparison circuit, which is clocked with the operating clock signal, receives a data block read from the synchronous circuit to be tested, which data block has a specific number n of data words each comprising m data bits, and compares it with associated desired data words, each comprising m desired data, for the purpose of generating a corresponding number n of error data words each comprising m error data,

a data register array, which has a plurality of data registers for buffer-storing the error data words generated,

a first error compression circuit, which logically ORs the error data words buffer-stored in the data register array to form a compressed error data word comprising m error bits, the error data word being buffer-stored in an error register,

and having a second error compression circuit, which logically ORs the m error data contained in the error data word to form an indication datum, the indication datum being output to the external test unit with the low clock frequency, and indicating whether at least one data error has occurred in the data block read from the synchronous circuit to be tested.

One advantage of the test circuit according to the invention is that only one indication datum is output via a feedback message signal to the external test unit for each synchronous circuit to be tested, so that the outlay on circuitry for the external test unit is very low.

A further considerable advantage of the test circuit according to the invention is that the external test unit can be operated with a very much lower clock frequency than the synchronous circuit to be tested. Comparatively simple test units can therefore be used.

In one preferred embodiment of the test circuit according to the invention, the desired data words are generated by a test data pattern generator contained in the test circuit.

In a further preferred embodiment of the test circuit according to the invention, the data registers of the data register array can be read via n data lines for error analysis by the test unit.

The advantage here is that, after the occurrence of a data error in a read-out data block, the test unit can exactly analyze the [sic] location at which the data error occurred.

In a further preferred embodiment of the test circuit according to the invention, the error register can be read via a data line for error analysis by the test unit.

In the test circuit according to the invention, the data comparison circuit is preferably connected via an internal data bus having a width of m bits to the data register array, the first error compression circuit and the second error compression circuit.

The data register array preferably has a plurality of demultiplexers for writing error data words present on the internal data bus in parallel to the various data registers.

The data registers of the data register array are preferably parallel-loadable shift registers which can be read serially for error analysis to a first input of a multiplexer.

The error register contained in the first error compression circuit is preferably a parallel-loadable shift register which can be read serially for error analysis to a second input of the multiplexer.

The indication datum generated by the second error compression circuit is preferably applied to a third input of the multiplexer via a line.

In a preferred embodiment of the test circuit according to the invention, the multiplexer has an output connected to the external test unit.

In a particularly preferred embodiment of the test circuit according to the invention, the test circuit has an internal controller for driving the data register array, the first error compression circuit, the second error compression circuit and the multiplexer.

In one embodiment, the test circuit according to the invention is integrated in the synchronous circuit to be tested.

The test circuit according to the invention is preferably used for testing a synchronous memory module.

The invention furthermore provides a method for testing a synchronous circuit having the following steps, namely

reading-in of a data block from the circuit to be tested with a high operating clock frequency,

comparison of the data of the data block read in with desired data for the purpose of generating error data,

buffer-storage of the error data in a data register array,

compression of the error data buffer-stored in the data register array to form an indication datum which indicates whether at least one data error is contained in the data block read in, and

transmission of the indication datum to a test unit with a low clock frequency for further error analysis.

Preferred embodiments of the test circuit according to the invention for testing a synchronous circuit and of the test method according to the invention are described below with reference to the accompanying figures.

In the figures:

FIG. 1 shows a test arrangement according to the prior art;

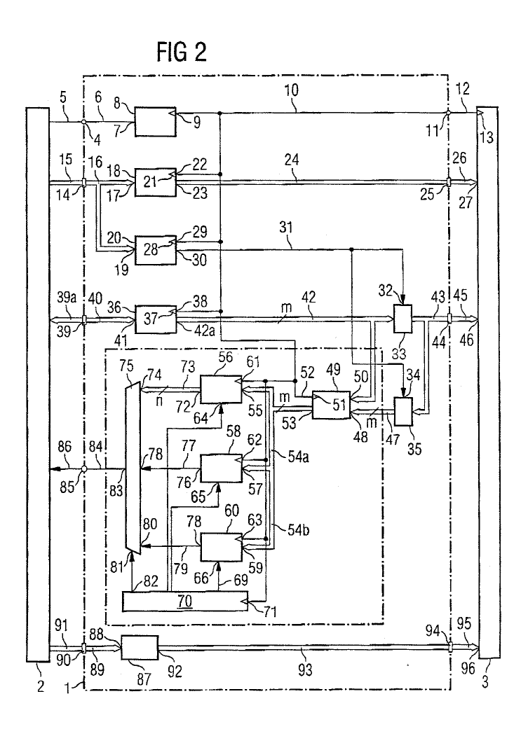

FIG. 2 shows a particularly preferred embodiment of the test circuit according to the invention;

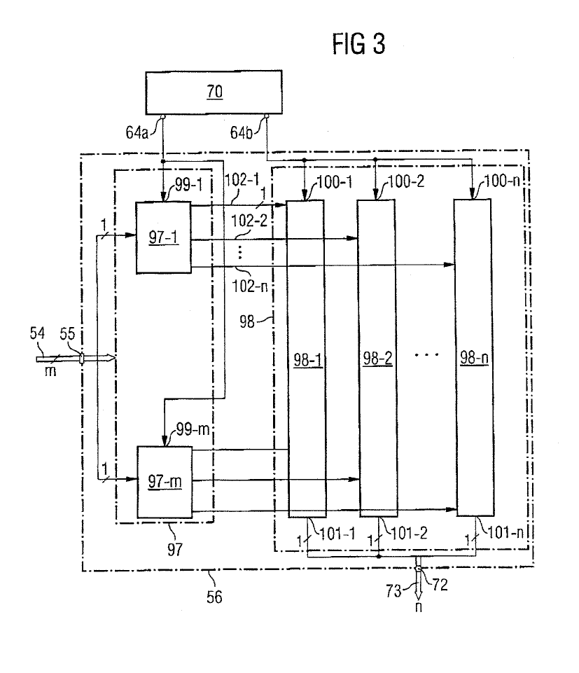

FIG. 3 shows a block diagram of a particularly preferred embodiment of the data register array contained in the test circuit according to the invention;

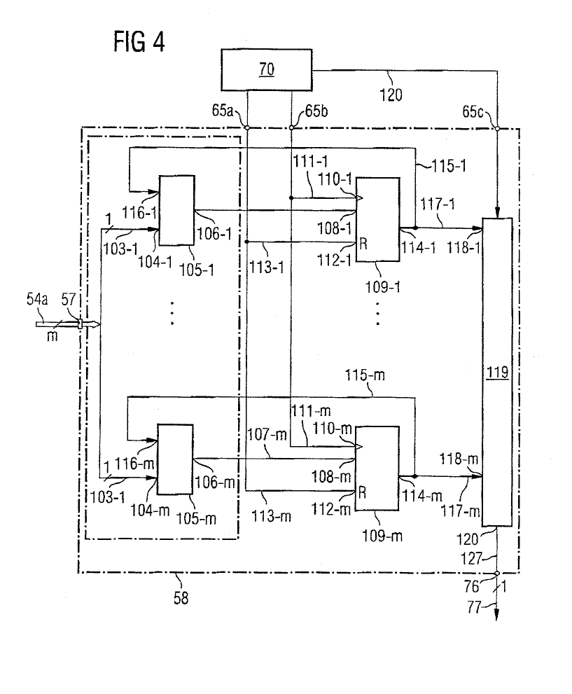

FIG. 4 shows a particularly preferred embodiment of the first error compression circuit contained in the test circuit according to the invention;

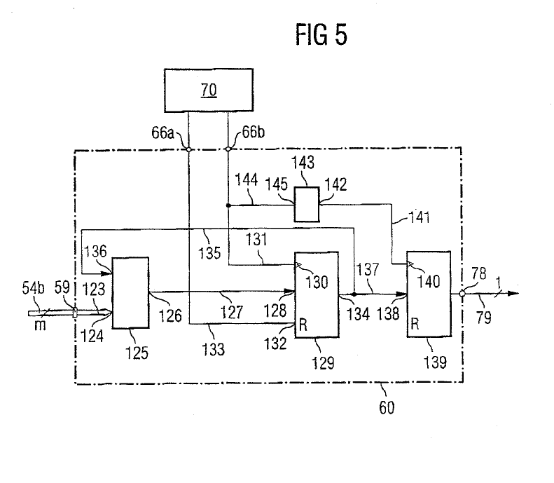

FIG. 5 shows a block diagram of the particularly preferred embodiment of the second error compression circuit contained in the test circuit according to the invention;

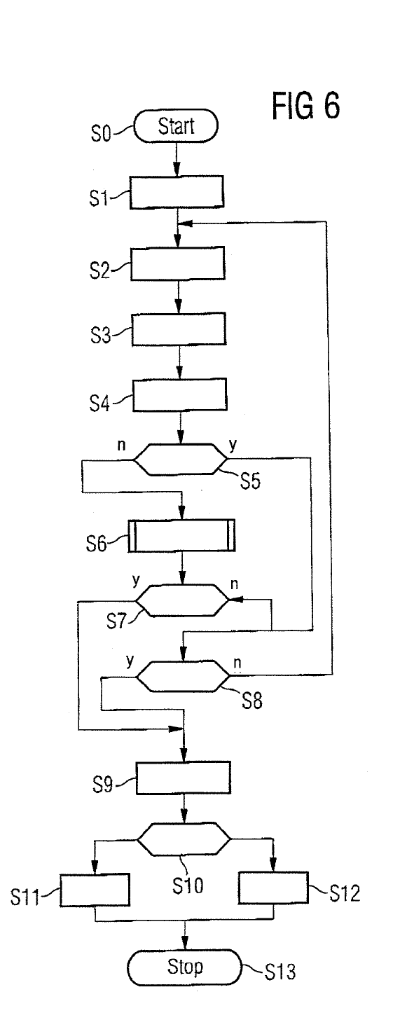

FIG. 6 shows a flow diagram for elucidating the test method according to the invention;

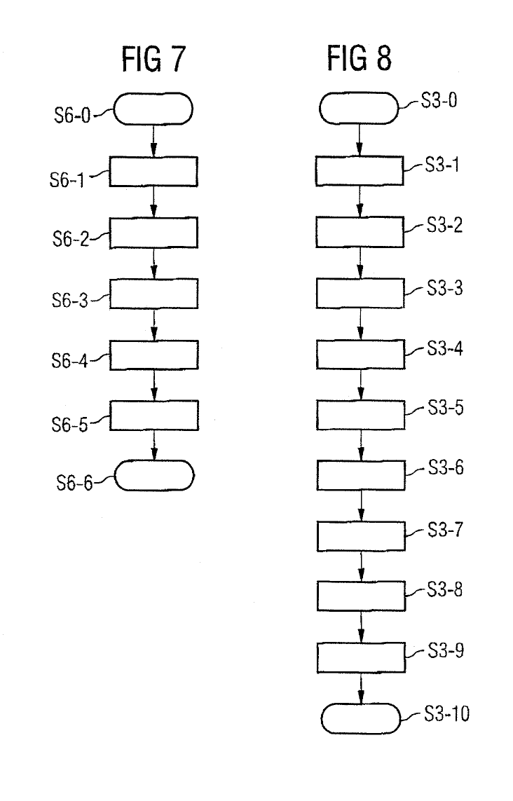

FIG. 7 shows a flow diagram for elucidating the error analysis within the test method according to the invention;

FIG. 8 shows a further flow diagram for elucidating the processing of a data block within the test method according to the invention.

FIG. 2 shows a preferred embodiment of the test circuit according to the invention for testing a synchronous circuit. The test circuit 1 according to the invention is provided between an external test unit 2 and a synchronous circuit 3 to be tested. The test circuit 1 has a clock input 4, which receives a relatively low-frequency clock signal from the external test unit 2 via a clock line 5 and outputs it to an input 7 of an internal frequency multiplication circuit 8 via an internal clock line 6. The frequency multiplication circuit 8 multiplies the low clock frequency of the clock signal output by the external test unit 2 by a specific factor k in order to achieve the operating clock frequency of the synchronous circuit 3 to be tested. The test unit 2 outputs, for example, a relatively low-frequency clock signal with a clock frequency of 100 MHz, which is increased by a factor of four by the frequency multiplication circuit 8. The frequency multiplication circuit 8 outputs the operating clock signal of 400 MHz, for example, to a clock output 11 of the test circuit 1 according to the invention via an output 9 and an internal clock line 10. The clock output 11 is connected via a clock line 12 to a clock input 13 of the circuit 3 to be tested.

In a preferred embodiment, the frequency multiplication factor k of the frequency multiplication circuit 8 can be set via a setting line.

In addition to the clock input 4, the test circuit 1 has a control input 14, which receives relatively low-frequency control signals from the external test unit 2 via a control bus 15 and applies them to an input 17 of a parallel/serial converter circuit 18 and to an input 19 of an evaluation logic circuit 20 via an internal control bus 16. Each control signal output by the external test unit 2 is simultaneously output via a plurality of control lines of the control signal bus 15 and output by the parallel/serial converter circuit 18 as a high-frequency control signal via a control line to the circuit 3 to be tested. The parallel/serial converter circuit 18 has a clock input 21 and receives the operating clock signal with a high clock frequency of 400 MHz, for example, via a clock line 22. The parallel/serial converter circuit 18 has an output 23, which is connected to a control output 25 of the test circuit 1 via an internal control signal bus 24. The control output 25 of the test circuit 1 is connected via a control bus 26 to a control bus 27 of the circuit 3 to be tested.

The evaluation logic 20 likewise has a clock signal input 28, which receives the high-frequency operating clock signal via a control line 29. The evaluation logic 20 receives the low-frequency control signals from the external test unit 2 via the input 19 and generates internal control signals for internal circuits of the test circuit 1 in a manner dependent on the external control signals. The generated internal control signals are applied via a control output 30 of the evaluation logic 20 and an internal control bus 31 for the control of internal structural components of the test circuit 1. In the embodiment illustrated in FIG. 2, the evaluation logic 20 is applied via the internal control bus 31 to a control input 32 of a data output driver 33 and a control input 34 of a data input driver 35. The internal evaluation logic 20 of the test circuit 1 makes it possible to obviate additional control lines from the test unit 2 to the test circuit 1 for driving internal structural components of the test circuit 1.

The test circuit 1 according to the invention furthermore contains a test data generator 36 for generating test data patterns, which is likewise clocked with the high-frequency operating clock signal via a clock input 37 and an internal clock line 38. Via data control lines 38, the test unit 2 applies control signals for controlling the test data pattern generator 36 to a control input 39 of the test circuit 1, which input is connected via data control lines 40 to a control input 41 of the test data pattern generator 36. The test data pattern generator 36 generates data for testing the synchronous circuit 3 in a manner dependent on the low-frequency data control signals present at the control input 41. In this case, the test data patterns are preferably already stored in data registers and are output by the test data pattern generator 36 with the high operating clock frequency via a data output 42a to an internal data bus 42—having a width of m bits—of the test circuit 1. In a writing operating mode of the test circuit 1 according to the invention, in which the data output driver 33 is activated by the evaluation logic 20, the generated test data are output from the data output driver 33 via a data bus 43 to a data output 44 of the test circuit 1 and from there via an external data bus 45 to a data input 46 of the circuit 3 to be tested. In a reading operating mode of the test circuit 1 according to the invention, the data input driver 35 is activated by the evaluation logic 20 via the internal control bus 31, and data which are read from the circuit 3 to be tested are applied to a data input 48 of a data comparison circuit 49 by the data input driver 35 via an internal data bus 47. The data comparison circuit 49 has a further data input 50, which is connected via the internal data bus 42 to the data output 42a of the test data pattern generator 36. The clocked data comparison circuit 49 has a clock input 51 and is likewise supplied with the high-frequency operating clock signal via a clock line 52. The data comparison circuit 49 furthermore has a data output 53, which is connected via an internal data bus 54a of the test circuit 1 to a data input 55 of a data register array 56 and to a data input 57 of a first error compression circuit 58, which is connected via an internal data bus 54b to a data input 59 of a second error compression circuit 60. The data register array 56 has a clock input 61 and is clocked with the high-frequency operating clock signal.

The first error compression circuit 58 and the second error compression circuit 60 likewise each have a clock input 62, 63 for receiving the high-frequency clock signal of 400 MHz, for example. The data register array 56, the first error compression circuit 58 and the second error compression circuit 60 each have control inputs 64, 65, 66 and are driven via control lines 67, 68, 69 by an internal controller 70 for data block evaluation, the internal controller 70 likewise being clocked with the high-frequency operating clock signal via a clock input 71. The data register array 56 has a data output 72, which is connected to a first input 74 of a multiplexer 75 via an internal data bus 73 having a width of n bits. The first error compression circuit 58 likewise has an output 76, which is connected via a data line 77 and a further data input 78 of the multiplexer 75.

The second error compression circuit 60 is connected via a data output 78 and a data line 79 to a third input 80 of the multiplexer 75. The multiplexer 75 furthermore has a control input 81, which is driven by the internal controller 70 via a control line 82. The multiplexer 75 has an output 83, which is connected via lines 84 to an output 85 of the test circuit 1 according to the invention. The output 85 of the test circuit 1 is connected to the external test unit 2 via lines 86.

The test circuit 1 preferably furthermore contains an address generator 87, which is connected to a control input 90 of the test circuit 1 via an input 88 and internal address control lines 89. The control input 90 of the test circuit 1 receives low-frequency address control signals from the external test unit 2 via address control lines 91 and forwards said signals to the address generator 87. In a manner dependent on the address control signals present, the address generator 87 generates address signals for addressing memory cells within the circuit 3 to be tested and outputs these addresses via an output 92 and an internal address bus 93 to an address output 94 of the test circuit 1. The address output 94 of the test circuit 1 is connected via an external address bus 95 to an address input 96 of the circuit 3 to be tested.

The data comparison circuit 49 clocked with the operating clock signal receives data, which are read from the synchronous circuit 3 to be tested, as a data block which has a specific number of data words each comprising m data bits. The received data words are applied to the first input 48 of the data comparison circuit 49 and compared with the expected desired data words which are present at the data input 50 and are generated by the test data pattern generator 36. Depending on the comparison result, error data words each having a width of m bits are output to the internal data bus 54a by the data comparison circuit 49. The data comparison by the data comparison circuit 49 is effected bit by bit, in which case, by way of example, each discrepancy is identified by a logic high data bit of the error data word, while correspondences between the generated test data pattern and the test data read out are identified by a logic low error data bit.

The error data words generated for each data block read in are written from the data comparison circuit 49 via the internal data bus 54a to the data register array 56, which contains a plurality of data registers, and buffer-stored there. Each error data word is buffer-stored in a corresponding data register for further data compression.

The first error compression circuit 58 compresses the error data words buffer-stored in the data register array 56 to form a compressed error data word, comprising m error bits, by logic ORing, the compressed error data word being buffer-stored in an error register of the first error compression circuit 58.

The second error compression circuit 66 again compresses the error data or error bits contained in the already compressed error data word by means of a further logic ORing to form an indication datum. The indication datum is output from the second error compression circuit 60 via the third input 80 of the multiplexer 75 and via the output 83 thereof to the external test unit 2 with a low clock frequency and indicates whether or not at least one data error has occurred in the last data block read from the synchronous circuit 3 to be tested.

FIG. 3 shows a particularly preferred embodiment of the data register array 56. The error data words present via the internal data bus 54a having a width of m bits are written via m demultiplexers 97-1 to 97-m to parallel-loadable shift registers 98-1 to 98-n and buffer-stored there.

For each of the n clock cycles of a received data burst, i.e. the number n of data words contained in the data block, a dedicated data register 98 is provided in the data register array 56. The demultiplexers 97-1 to 97-m each have control inputs 99-1 to 99-m and are driven by the internal controller 70. The internal controller 70 furthermore drives the data registers 98-1 to 98-n via control inputs 100-1 to 100-n. The data registers 98-1 to 98-n, designed as shift registers, each have an output 101-1 to 101-n for reading out the data words—contained therein—of the received data word. Each bit of a received data word is written by a multiplexer 97-i via lines 102-1 to 102-n in accordance with the clock cycle i to the associated data register 98-i and subsequently read out for further data compression. The data registers 98-1 to 98-n buffer-store the error data words generated by the data comparison circuit 49, in which case preferably a logic high error data bit is buffer-stored for each discrepancy in the data register array 56, while a logic low data bit is buffer-stored for each correspondence. If the data block read in from the circuit 3 to be tested does not deviate at any location from the expected test data pattern, exclusively logic low error bits are written in the data registers 98-1 to 98-n. Each logic high error bit indicates a discrepancy that has occurred between the expected test data pattern and the read-in data block.

FIG. 4 shows a particularly preferred embodiment of the first error compression circuit 58 contained in the test circuit 1 according to the invention. Via the input 57, the error compression circuit 58 receives the error data words output to the internal data bus 54a by the data comparison circuit 49 and applies the error bits contained in the error data word via internal lines 103-1 to 103-m to inputs 104-1 to 104-m of OR gates 105-1 to 106-m [sic] of an OR logic circuit 105. The outputs 106-1 to 106-n are connected via internal lines 107-1 to 107-m [lacuna] data inputs 108-1 to 108 -m of clocked flip-flops 109-1 to 109-m. The flip-flops 109-1 to 109-m each have clock inputs 110-1 to 110-m, which receive the high-frequency operating clock signal from the internal controller 70 via clock lines 111-1 to 111-m. The clocked flip-flops furthermore have reset inputs 112-1 to 112-m, which receive a reset signal from the internal controller 70 via reset lines 113-1 to 113-m. The flip-flops 109-1 to 109-m furthermore each have an output 114-1 to 114-m, which is connected via a feedback line 115-1 to 115-m to a further input 116-1 to 116-m of an OR gate 105-1 to 105-m. The output 114-i of a clocked flip-flop 109-i is furthermore connected via an associated data line 117-i to a data input 118-i of the parallel-loadable shift register 119. The parallel-loadable shift register 119 can be read serially via an output 120 to a line 121 to a data output 76 of the first error compression circuit 58. The error data words present at the input 57 over a plurality of clock cycles are logically ORed by the first error compression circuit 58 and compressed to form a single compressed or cumulated error data word. The compressed error data word is preferably read out after n clock cycles from the error register 119 for further compression by the second error compression circuit 60. For this purpose, the error register 119 is driven by the internal controller 70 via a control line 122.

FIG. 5 shows a particularly preferred embodiment of the second error compression circuit 60.

Via a further data bus 54b, at a data input 59, the second error compression circuit 60 receives the already compressed error data word comprising m bits from the first compression circuit 58. The compressed error data word is applied via internal data lines 123 to an input 124 of an OR logic circuit 125, which logically ORs the various error bits of the compressed error data word present with one another. The OR logic 125 has an output 126, which is connected via a line 127 to an input 128 of the clocked flip-flop 129. The flip-flop 129 has a clock input 130 and receives the high-frequency operating clock signal of 400 MHz, for example, via an internal clock line 131 from the internal controller 70. The flip-flop 129 furthermore has a reset input 132, which can be driven by the internal controller 70 via a reset line 133. The flip-flop 129 has a data output 134, which is connected via a feedback line 135 to an input 136 of the OR logic 125. The data output 134 of the flip-flop 129 is furthermore connected via a data line 137 to a data input 138 of a further clocked flip-flop 139 having a clock input 140. The clock input 140 of the second flip-flop 139 is connected via an internal clock line 141 to an output 142 of a frequency divider 143. The frequency divider 143 receives the high-frequency operating clock signal of 400 MHz, for example, from the internal controller 70 via an internal clock line 144 and a clock input 145 and divides the clock frequency of said signal down by a constant factor k. This constant factor k corresponds to the frequency multiplication factor of the frequency multiplication circuit 8. The high-frequency operating clock signal present is divided down by a factor of four, for example, to a low-frequency clock frequency of 100 MHz by the frequency divider 143. The error compression circuit 60 logically ORs the error data or error bits contained in the compressed error data word to form a single indication datum or indication bit, the indication datum being output to the external test unit with the low clock frequency of 100 MHz, for example, and indicating whether or not at least one data error has occurred in the entire data block received from the circuit 3 to be tested. There is thus an identification of whether, in the last n clock cycles or in the last n data words, a discrepancy has occurred between the expected data and the received data and there is thus a defective memory cell within the memory module 3 to be tested.

FIG. 6 shows a flow diagram for elucidating the test method according to the invention for the testing of the synchronous circuit 3 by the test circuit 1 according to the invention.

After a start step S0, after the resetting of an error counter, in a step S1, the test circuit 1 can apply the test data output by the test data pattern generator 36 via the activated data output driver 33 and the data bus 45 to the synchronous circuit 3 to be tested.

In a step S2, a data block from the synchronous circuit 3 is read in via the data bus 45 and the data input driver 35 of the test circuit 1, the data block comprising n data words each comprising m bits.

In a step S3, the read-in data block is subjected to data processing by the test circuit 1. The data processing by the test circuit 1 is illustrated in detail in FIG. 8.

After a start step S3-0, in a step S3-1, a bit-by-bit data comparison is effected between the data block read from the synchronous circuit 3 and the associated desired data block comprising the expected data. In this case, the n data words of the read-out data block are compared in corresponding m desired data words by the data comparison circuit 49, and, in a step S3-2, the data comparison circuit 49 generates n difference or error data words, which are buffer-stored in the data register array 56 via the internal data bus 54a in a step S3-3.

In a further step S3-4, a first error compression is effected by the first error compression circuit 58. In this case, the n error data words buffer-stored in the data register array are logically ORed to form a single compressed error data word comprising m error bits and buffer-stored in an error register in a step S3-5.

In a further step S3-6, the data bit groups of all the error data words are ORed with associated data bits from an address error register array and buffer-stored in a step S3-7.

In a step S3-8, the second error compression circuit 60 cumulates or compresses all m error data bits of the cumulated error data word to form an indication datum by logic ORing.

In a further step S3-9, the indication datum is applied to the third input 80 of the multiplexer 75 by the second error compression circuit. The subroutine is then left in a step S3-10.

As can be seen in FIG. 6, after the data processing of the read-in data block in step S3, which lasts n clock cycles, in a step S4, the indication datum which is generated by the second error compression circuit 60 and indicates whether or not the read-in data block is free of errors is applied to the test unit 2 via a line 86.

In a step S5, the test unit 2 uses the indication datum present to check whether or not the read-in data block is free of errors. If the indication datum is logic high and thus indicates that at least one data error has occurred in the read-in data block, the test unit 2 initiates an error analysis of the data block 1 in a step S6.

FIG. 7 shows the error analysis in detail. After a start step S6-0, the test circuit 1 according to the invention is put into an error analysis operating mode by the external test unit 2 in a step S6-1. Afterward, in a step S6-2, the data content of the data register array 56 is read out via the lines 73 and the multiplexer 75, and, in a step S6-3, an internal error counter is incremented by the number of set error bits contained in the data register array 56. Optionally, in a step S6-4, an address information item with regard to the set error bits is output by the test unit 2 and buffer-stored. Afterward, in a step S6-5, the test circuit 1 according to the invention is changed over from the error analysis mode back into a test mode. The subroutine is thereupon left in a step S6-7.

As can be seen from FIG. 6, in a further step S7, a check is made to determine whether or not the number of errors that have occurred has reached a threshold value.

If the threshold value has not yet been reached, in a step S8, a check is made to determine whether or not an end of test has been reached. If the test is not yet at an end, the procedure returns to step S2, otherwise the error register is read in a step S9.

In a step S10, the test unit checks whether the circuit 3 to be tested is functional, i.e. whether or not the number of data errors that have occurred lies within a repairable threshold value. If the number of errors that have occurred lies below the threshold value, step S11 effects indication that the circuit 3 to be tested is functional and released for supply. If the number of data errors that have occurred has exceeded the threshold value, the circuit 3 to be tested is identified as non-functional and, in a step S12, an error log is output to the test unit. Finally, the test method is ended in a step S13.

The test circuit 1 according to the invention results in a reduction of the requirements made of the test unit 2 with regard to the data bandwidth and the number of channels for each circuit 3 to be tested. The test unit 2 can operate with a relatively low clock frequency compared with the high-frequency operating clock of the memory module 3 to be tested. In this case, it receives from the test circuit 1 only one feedback message signal or indication datum which indicates whether or not the data block read in last is free of errors. If this compressed information indicates that the data block is defective, the location at which the data error occurred or the memory cell within the memory module 3 which is defective will be ascertained exactly in an error analysis mode. The transfer frequency with which the indication datum is [lacuna] from the error compression circuit to the test unit 2 likewise lies distinctly below the operating clock frequency of the memory module 3 to be tested. The data register array 56 enables a bit-accurate error analysis which was previously possible only without compression with a relatively wide data bus between the test unit 2 and the memory module 3 to be tested. The error register directly acquires the defective data bits throughout the course of the test, in which case the error register has to be read only relatively infrequently by the test unit 2 and so a small bandwidth is required for the signal transfer. The compressed indication datum or pass-fail signal enables highly parallel testing, only one input channel for each circuit to be tested having to be provided on the test unit 2 with a relatively low data transfer rate. The test circuit 1 is preferably arranged as near as possible to the circuit 3 to be tested, so that the lines for transmitting the high-frequency control data and address signals are as short as possible and thus relatively insensitive to signal interference. In a particularly preferred embodiment, the test circuit 1 according to the invention is integrated directly into the memory module 3 to be tested.

The test circuit 1 according to the invention enables the use of relatively simple conventional test units 2 for reliably testing memory modules 3 which operate at far higher operating clock frequencies. In this case, the outlay on circuitry for the additional test circuit 1 is relatively low.

List of reference symbols

| | |
|---|---|
| 1 | Test circuit |
| 2 | Test unit |
| 3 | Synchronous circuit to be tested |
| 4 | Clock input |
| 5 | Clock line |
| 6 | Clock line |
| 7 | Input |
| 8 | Frequency multiplication circuit |
| 9 | Output |
| 10 | Clock signal line |
| 11 | Clock output |
| 12 | Clock line |
| 13 | Clock input of the synchronous circuit (3) |
| 14 | New input |
| 15 | New signal bus |
| 16 | Internal control signal bus |
| 17 | Control input |
| 18 | Parallel/serial converter |
| 19 | Input |
| 20 | Evaluation logic |
| 21 | Clock input |
| 22 | Clock line |
| 23 | Output |
| 24 | Control lines |
| 25 | Control output |
| 26 | Control lines |
| 27 | Control input of the synchronous circuit (3) |
| 28 | Clock input |
| 29 | Clock line |
| 30 | Output |
| 31 | Internal control bus |
| 32 | Control input |
| 33 | Data output driver |
| 34 | Control input |
| 35 | Data input driver |
| 36 | Test data generator |
| 37 | Clock input |
| 39 | Clock line |
| 39 | Control input |
| 39a | Control lines |
| 40 | Internal control lines |
| 41 | Control input |
| 42 | Internal data bus |
| 42a | Output |
| 43 | Internal data bus |
| 44 | Data output |
| 45 | Data bus |
| 46 | Data input of the synchronous circuit (3) |
| 47 | Internal data bus |
| 48 | Data input |
| 49 | Data comparison circuit |
| 50 | Data input |
| 51 | Clock input |
| 52 | Clock line |
| 53 | Data output |
| 54a,b | Internal data buses |
| 55 | Data input |
| 56 | Data register array |
| 57 | Data input |
| 58 | First error compression circuit |
| 59 | Data input |
| 60 | Second error compression circuit |
| 61 | Clock input |
| 62 | Clock input |
| 63 | Clock input |
| 64 | Control input |
| 65 | Control input |
| 66 | Control input |
| 67 | Control line |
| 68 | Control line |
| 69 | Control line |
| 70 | Internal controller |
| 71 | Clock input |
| 72 | Data output |
| 73 | Data lines |
| 74 | Multiplexer input |
| 75 | Multiplexer |
| 76 | Output |
| 77 | Data lines |
| 78 | Multiplexer input |
| 79 | Data line |
| 80 | Multiplexer input |
| 81 | Control input |
| 82 | Control line |
| 83 | Multiplexer output |
| 84 | Lines |
| 85 | Output |
| 86 | Lines |
| 87 | Address generator |
| 88 | Input |
| 89 | Control lines |
| 90 | Control input |
| 91 | Address control lines |
| 92 | Output |
| 93 | Internal address bus |
| 94 | Address output |
| 95 | Address bus |
| 96 | Address input of the synchronous circuit (3) |
| 97 | Demultiplexer |
| 98 | Data register |
| 99 | Control inputs |
| 100 | Control inputs |
| 101 | Register outputs |
| 102 | Data lines |
| 103 | Data lines |
| 104 | Inputs |
| 105 | OR gate |
| 106 | Outputs |
| 107 | Data lines |
| 108 | Inputs |
| 109 | Flip-flops |
| 110 | Clock inputs |
| 111 | Clock lines |
| 112 | Reset inputs |
| 113 | Reset lines |
| 114 | Outputs |
| 115 | Feedback lines |
| 116 | Inputs |
| 117 | Data lines |
| 118 | Inputs |
| 119 | Error register |
| 120 | Register output |
| 121 | Output line |
| 122 | Control line |
| 123 | Data lines |
| 124 | Inputs |
| 125 | OR logic |
| 126 | Output |
| 127 | Line |
| 128 | Input |
| 129 | Flip-flop |
| 130 | Clock input |
| 131 | Clock line |
| 132 | Reset input |
| 133 | Reset line |
| 134 | Output |
| 135 | Feedback line |
| 136 | Input |
| 137 | Line |
| 138 | Line |
| 139 | Flip-flop |
| 140 | Clock input |
| 141 | Clock line |
| 142 | Output |
| 143 | Frequency divider |
| 144 | Clock line |
| 145 | Input |

1. Test circuit for testing a synchronous circuit (3) which is clocked with an operating clock signal with a high operating clock frequency, having:
(a) a frequency multiplication circuit (8), which receives a clock signal from an external test unit (2) and multiplies the low clock frequency of said clock signal by a specific factor for the purpose of generating the operating clock signal;
(b) a data comparison circuit (49), which is clocked with the operating clock signal, receives a data block read from the synchronous circuit (3) to be tested, which data block has a specific number (n) of data words n each comprising m data bits, and compares it with associated desired data words, each comprising m desired data, for the purpose of generating a corresponding number (n) of error data words each comprising m error data;
(c) a data register array (56), which has a plurality of data registers for buffer-storing the error data words generated;
(d) a first error compression circuit (58), which logically ORs the error data words buffer-stored in the data register array (56) to form a compressed error data word comprising m error bit [sic], which is buffer-stored in an error register;
(e) and having a second error compression circuit (60), which logically ORs the m error data contained in the compressed error data word to form an indication datum, the indication datum being output to the external test unit (2) with the low clock frequency, and indicating whether at least one data error has occurred in the data block read from the synchronous circuit (3) to be tested.

2. Test circuit according to claim 1,
characterized
in that the desired data words are generated by a test data pattern generator (36) contained in the test circuit (1).

3. Test circuit according to claim 1 or 2,
characterized
in that the data registers of the data register array (56) can be read via data lines (72, 84, 86) for error analysis by the test unit (2).

4. Test circuit according to one of the preceding claims,
characterized
in that the error register (119) can be read via a data line (77) for error analysis by the test unit (2).

5. Test circuit according to one of the preceding claims,
characterized
in that the data comparison circuit (49) is connected via a first internal data bus (54a) to the data register array (56) and the first error compression circuit (58), which is connected via a second internal data bus (54b) to the second error compression circuit (60).

6. Test circuit according to one of the preceding claims,
characterized
in that the data register array (56) has a plurality of demultiplexers (97) for writing error data words present on the internal data bus (54) in parallel to the various data registers (98).

7. Test circuit according to one of the preceding claims,
characterized
in that the data registers (98) of the data register array (56) are parallel-loadable shift registers which can be read serially for error analysis at a first input of a multiplexer (75).

8. Test circuit according to one of the preceding claims,
characterized
in that the error register (119) of the first error compression circuit (58) is a parallel-loadable shift register which can be read serially for error analysis to a second input (78) of the multiplexer (75).

9. Test circuit according to one of the preceding claims,
characterized
in that the indication datum generated by the second error compression circuit (60) is present at a third input (80) of the multiplexer via a line (79).

10. Test circuit according to one of the preceding claims,
characterized
in that the multiplexer (75) has an output (83) connected to the external test unit (2).

11. Test circuit according to one of the preceding claims,
characterized
in that the test circuit (1) has an internal controller (70) for driving the data register array (56) [lacuna] the first error compression circuit (58), the second error compression circuit (60) and the multiplexer (75).

12. Test circuit according to one of the preceding claims,
characterized
in that the test circuit (1) is integrated in the synchronous circuit (3) to be tested.

13. Use of the test circuit according to one of the preceding claims 1 to 12 for testing a synchronous memory.

14. Method for testing a synchronous circuit having the following steps:
(a) reading-in of a data block from the circuit (3) to be tested with a high operating clock frequency;
(b) comparison of the data of the data block read in with desired data for the purpose of generating error data;
(c) buffer-storage of the error data in a data register array (56);
(d) compression of the error data buffer-stored in the data register array (56) to form an indication datum which indicates whether at least one data error is contained in the data block read in;
(e) transmission of the indication datum to a test unit (2) with a low clock frequency for further error analysis.
